(19) United States
(12) Patent Application Publication
(10) Pub. No.: US 2026/0249769 A1
(43) Pub. Date: Aug. 27, 2026

(54) UTILITY LAYERS FOR RECREATIONAL VEHICLES

(71) Applicant: Winnebago Industries, Inc., Eden Prairie, MN (US)

(72) Inventor: Brian Daniel Durbin, La Grange, KY (US)

(21) Appl. No.: 19/548,017

(22) Filed: Feb. 24, 2026

Related U.S. Application Data
(60) Provisional application No. 63/762,400, filed on Feb. 24, 2025.

(51) Int. Cl. B60P 3/32; B60H 1/00; B60N 3/10; B60N 3/16; B60R 15/02; B60R 15/04; B60R 16/02; B60R 16/033; B62D 25/24

(52) U.S. Cl. CPC B60P 3/32; B60N 3/104; B60N 3/16; B60R 15/02; B60R 15/04; B60R 16/0207; B60R 16/033; B62D 25/24; B60H 1/00364

(57) ABSTRACT

A recreational vehicle includes a towable chassis including wheels, a utility layer on the chassis, a house on the chassis above the utility layer, and one or more functional interconnections. The utility layer includes one or more utilities. The house includes one or more appliances. Each of the one or more functional interconnections couples at least one of the one or more utilities to at least one of the one or more appliances. The functional interconnections may comprise one or more of plumbing, wires, or ducts. Examples of utilities include a battery, an electrical system, a pump, a water heater, or a heating, ventilating and air conditioning (HVAC) unit. Examples of appliances include a faucet, a drain, a toilet, lighting, an electrical outlet, a stove, a cooktop, a refrigerator, or one or more air vents.

### CROSS REFERENCE TO RELATED APPLICATION

This application claims priority to Provisional Application No. 63/762,400, filed Feb. 24, 2025, which is herein incorporated by reference in its entirety.

### FIELD

This disclosure relates generally to recreational vehicles (RVs) including a chassis and a house on the chassis. Disclosed embodiments include towable RVs with a utility layer for utilities such as batteries, electrical systems, pumps, heaters or heating ventilating and air conditioning (HVAC) units between the chassis and house.

### BACKGROUND

Recreational vehicles (RVs) typically include a house or living area on a chassis. The vehicles may include appliances, utilities coupled to the appliances, and furniture. Examples of such appliances include, for example, sinks and showers with drains and/or water faucets, electrical outlets and vents for distributing conditioned air. Examples of such utilities include water tanks such as clean, grey and black water tanks, water heaters, pumps and heating, ventilation, and air conditioning (HVAC) systems. The utilities are functionally coupled to associated appliances, such as for example by electrical wiring, ducts and plumbing.

There remains a continuing need for improved RVs. For example, structures and methods that allow RVs to be configured for particular customers would be desirable. Structures and methods that enable the RVs to be efficiently manufactured would also be desirable.

### SUMMARY

Recreational vehicles (RVs) disclosed herein can be efficiently manufactured. They can also be customized to suit the needs of particular customers.

One example is a recreational vehicle comprising: a towable chassis including wheels; a utility layer on the chassis, the utility layer including one or more utilities; a house on the chassis above the utility layer, the house including one or more appliances; and one or more functional interconnections, wherein each of the one or more functional interconnections couples at least one of the one or more utilities to at least one of the one or more appliances.

In embodiments, the functional interconnections comprise one or more of plumbing, wires, or ducts. The one or more utilities may from a set of utilities including a battery, an electrical system, a pump, a water heater, or a heating, ventilating and air conditioning (HVAC) unit; and the one or more appliances may be from a set of appliances including a faucet, a drain, a toilet, lighting, an electrical outlet, a stove, a cooktop, a refrigerator, or one or more air vents.

In embodiments, the utility layer comprises a side panel, and one or more of the one or more utilities are accessible through the side panel. Embodiments may further comprise one or more sliding shelves, each sliding shelf mounting one or more of the one or more utilities for slidable access through the side panel.

In embodiments, the house includes one or more walls; and at least one of the one or more functional interconnections extend through the one or more walls.

In embodiments, the house includes a floor; and at least one of the one or more functional interconnections extend through the floor. For example, the house may include one or more walls; and at least one of the one or more functional interconnections extend through the one or more walls.

Another example is a method for manufacturing a recreational vehicle, comprising: providing a towable chassis; mounting a utility layer on the chassis; mounting a house on the utility layer after mounting the utility layer on the chassis; mounting one or more utilities on the utility layer; mounting one or more appliances in the house; and functionally coupling one or more of the one or more appliances to one or more of the one or more utilities. For example, mounting the utility layer on the chassis comprises: at least partially assembling the utility layer separate from the chassis; and mounting the at least partially assembled utility layer to the chassis.

In embodiments, at least partially assembling the utility layer separate from the chassis comprises: providing a plurality of utility layer compartments, and assembling the utility layer from one or more of the plurality of utility layer compartments. For example, mounting the utility layer on the chassis comprises:
providing a plurality of utility layer compartments; and mounting one or more of the plurality of utility layer compartments to the chassis.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1A is a diagrammatic isometric illustration of a recreational vehicle, in accordance with certain embodiments of the present disclosure, including a chassis having a frame, a utility layer, and a house.

FIG. 1B is a diagrammatic side view of the recreational vehicle shown in FIG. 1A, in accordance with certain embodiments.

FIG. 1C is a diagrammatic side view of the recreational vehicle shown in FIG. 1A, showing the side opposite the side shown in FIG. 1B, in accordance with certain embodiments.

FIG. 2 is a diagrammatic exploded isometric illustration of the recreational vehicle shown in FIG. 1A, in accordance with certain embodiments.

FIG. 3 is a diagrammatic top plan view of a utility layer for a recreational vehicle, in accordance with embodiments.

FIG. 4 is a diagrammatic illustration of a floor plan for a house for a recreational vehicle, in accordance with embodiments.

FIG. 5 is a diagrammatic illustration of a method for manufacturing a recreational vehicle, in accordance with embodiments.

FIG. 6 is a diagrammatic illustration of a towable recreational vehicle, such as a double interior module trailer, in accordance with embodiments.

FIG. 7 is a diagrammatic exploded isometric illustration of the recreational vehicle shown in FIG. 6, in accordance with embodiments.

FIG. 8 is a diagrammatic illustration of a floor plan of a kitchen/dining/lounge interior house module, in accordance with embodiments.

FIG. 9 is a diagrammatic illustration of a floor plan of a bathroom/kitchen interior house module, in accordance with embodiments.

FIG. 10 is a diagrammatic illustration of a floor plan of a bedroom interior house module, in accordance with embodiments.

FIG. 11 is a diagrammatic illustration of a floor plan of a bedroom interior house module, in accordance with embodiments.

FIG. 12 is a diagrammatic illustration of a floor plan of a kitchen/dining/lounge interior house module, in accordance with embodiments.

FIG. 13 is a diagrammatic illustration of a floor plan of a bathroom/dining/lounge interior house module, in accordance with embodiments.

FIG. 14 is a diagrammatic illustration of a floor plan of a bedroom/lounge interior house module, in accordance with embodiments.

FIG. 15 is a diagrammatic illustration of a floor plan of a kitchen/dining/lounge interior house module, in accordance with embodiments.

FIG. 16 is a diagrammatic illustration of a floor plan of a folding deck rear end cap house module, in accordance with embodiments.

FIG. 17 is a diagrammatic illustration of a floor plan of a folding deck rear end cap house module, in accordance with embodiments.

FIG. 18 is a diagrammatic illustration of a floor plan of a bathroom front end cap house module, in accordance with embodiments.

FIG. 19 is a diagrammatic illustration of a floor plan of a bathroom front end cap house module, in accordance with embodiments.

FIG. 20 is a diagrammatic illustration of a floor plan of a kitchen front end cap house module, in accordance with embodiments.

FIG. 21 is a diagrammatic illustration of a floor plan of a lounge front end cap house module, in accordance with embodiments.

FIG. 22 is a diagrammatic illustration of a floor plan of a kitchen/bathroom front end cap house module, in accordance with embodiments.

FIG. 23 is a diagrammatic illustration of a floor plan of a house of a double interior module trailer, in accordance with embodiments.

FIG. 24 is a diagrammatic illustration of a floor plan of a house of a double interior module trailer, in accordance with embodiments.

FIG. 25 is a diagrammatic illustration of a floor plan of a house of a double interior module trailer, in accordance with embodiments.

FIG. 26 is a diagrammatic illustration of a floor plan of a house of a double interior module trailer, in accordance with embodiments.

FIG. 27 is a diagrammatic illustration of a floor plan of a house of a double interior module trailer, in accordance with embodiments.

FIG. 28 is a diagrammatic illustration of a towable recreational vehicle, including a single interior module trailer, in accordance with embodiments.

FIG. 29 is a diagrammatic illustration of a floor plan of a house of a single interior module trailer, in accordance with embodiments.

FIG. 30 is an illustration of a house taken from within a house module of a single module trailer such as that shown in FIG. 29, in accordance with embodiments.

FIG. 31 is a diagrammatic illustration of a floor plan of a house of a single interior module trailer, in accordance with embodiments.

FIG. 32 is an illustration of a house taken from within a house module of a single module trailer such as that shown in FIG. 31, in accordance with embodiments.

FIG. 33 is a diagrammatic illustration of a floor plan of a house of a single interior module trailer, in accordance with embodiments.

FIG. 34 is a diagrammatic illustration of a towable recreational vehicle, including a triple interior module trailer, in accordance with embodiments.

FIG. 35 is a diagrammatic illustration of a towable recreational vehicle, including a long-length single interior module trailer in accordance with embodiments.

FIG. 36 is a diagrammatic illustration of a floor plan of a house of a long-length single module trailer, in accordance with embodiments.

FIG. 37 is a detailed isometric view of a portion of a house including a seal, in accordance with embodiments.

FIG. 38 is a an exploded view of the portion of the house shown in FIG. 39, in accordance with embodiments.

FIG. 39 is a detailed isometric view of a portion of a house including a seal, with the seal shown in an unconnected configuration, in accordance with embodiments.

FIG. 40 is a detailed isometric view of the seal shown in FIG. 39, with the seal shown in a connected configuration, in accordance with embodiments.

FIG. 41 is a top view of the seal shown in FIG. 40.

FIG. 42 is a diagrammatic illustration of a recreational vehicle, in accordance with certain embodiments of the present disclosure, that includes a chassis having a frame and utility layer, and a modular house.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope the appended claims.

### DETAILED DESCRIPTION

### Introduction

Embodiments of the present disclosure relate to components, structural arrangements and organizations, and methods, that can provide advantages such as efficiencies in the initial manufacture and/or serviceability of recreational vehicles (RVs). RVs commonly include a chassis with wheels, and a house, which is the living area, on the chassis. Appliances and furniture are typically located in the house. Examples of such appliances includes sinks with drains, showers with drains, toilets, faucets, lighting, electrical outlets, stoves, cooktops, refrigerators and air vents. The appliances are typically coupled to utilities, such as for example, batteries, electrical systems, pumps, water heaters, and heating, ventilating and air conditioning (HVAC) systems. Functional interconnections that couple the appliances to the utilities may include, for example, wires for electricity, pipes and/or other plumbing for water, and ducts for air. Certain embodiments are related to the placement, structure and organization of utilities and the functional interconnections. For example, the utilities can be located in a utility layer between the chassis and house. The functional interconnections between the utilities and the associated appliances may be effectively made through the floor and/or walls of the house. Locating the utilities in the utility layer may provide for enhanced access to the utilities, and may free up additional space in the house. Similarly, routing the functional interconnections between the utilities and appliances in these embodiments may free up additional space in the house.

Certain embodiments are related to modular house components or house modules that can be at least partially prefabricated (e.g., separate and apart from the chassis) and assembled onto a chassis in the prefabricated form. Structures such as seals can be placed between the adjacent modules to structurally couple or join the modules, and to sufficiently seal the joined portions of the house modules from the outside environment (e.g., to prevent or minimize water ingress and air flow). Manufacturing the modules before they are assembled onto the chassis enhances manufacturing efficiencies. Examples of such modules include modules with different bedroom, kitchen, lounge, porch and/or bathroom layouts or floorplans, and can include interior modules, rear end cap modules, and front end cap modules. The ability to select particular modules and the arrangement of their locations on the chassis enhances the ability of customization of the RVs.

### Recreational Vehicles With Utility Layers

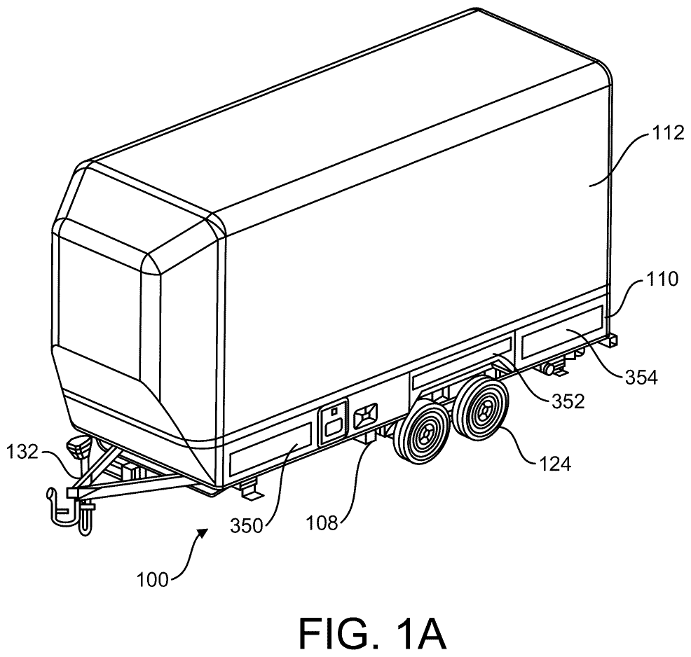

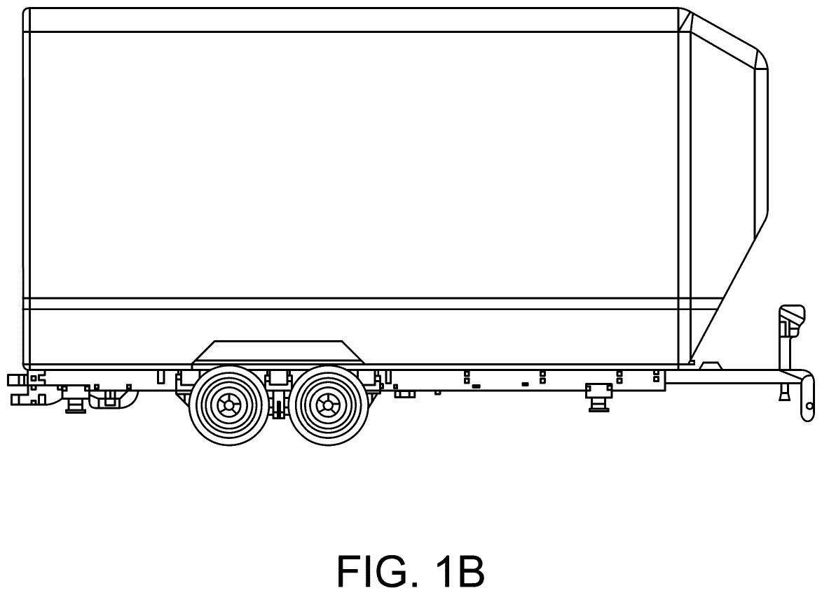

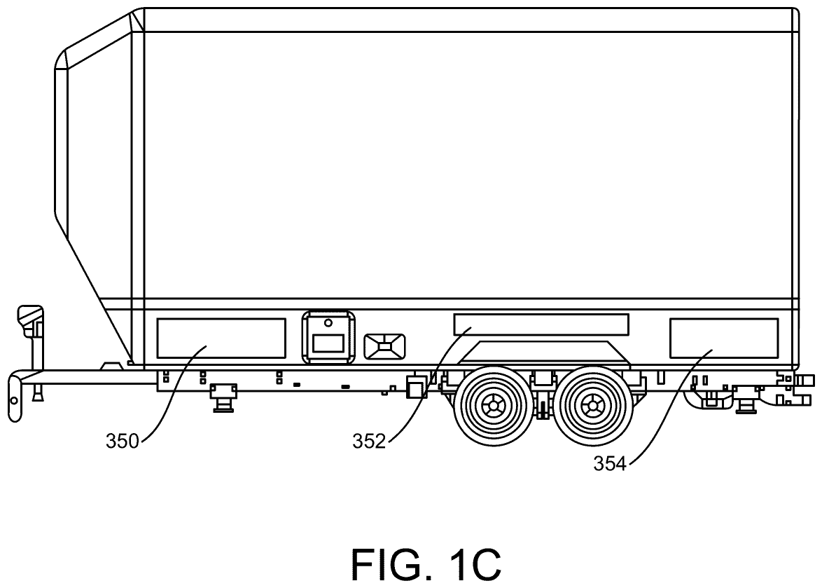

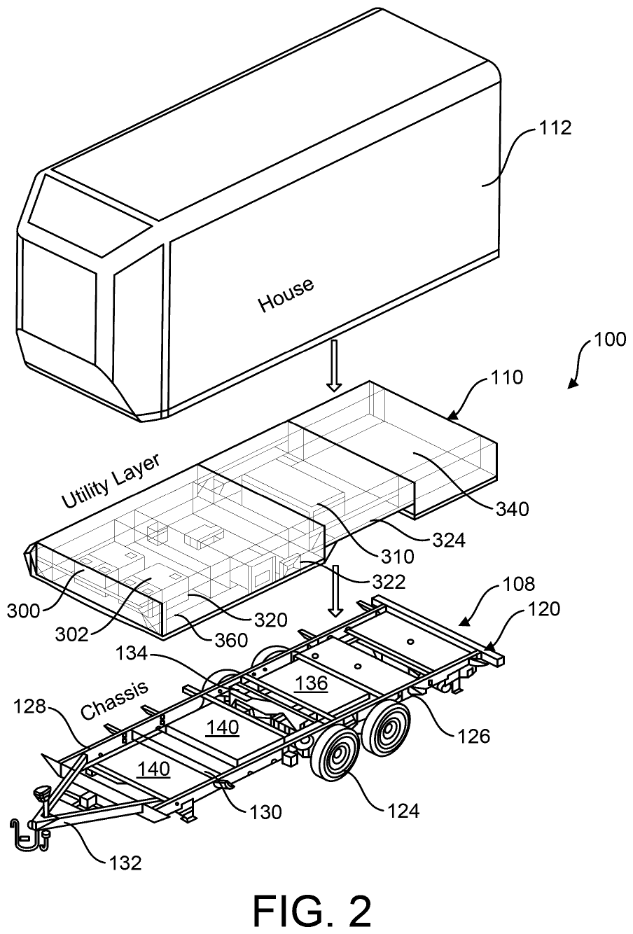

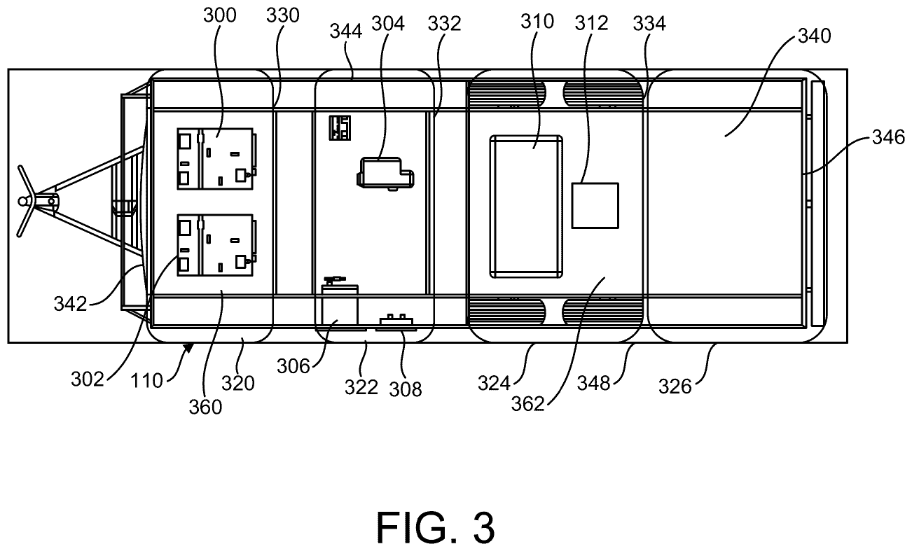

FIGS. 1A-1C are diagrammatic illustrations of a towable recreational vehicle (RV) such as a travel trailer 100, which includes a chassis 108, utility layer 110 and house 112 in accordance with embodiments. FIG. 2 is an exploded diagrammatic illustration of the travel trailer 100, showing the chassis 108, utility layer 110 and house 112. FIG. 3 is a diagrammatic top plan view of the utility layer 110. The house 112 is a body that houses a living area including furniture and appliances. Utility layer 110, which is located on the chassis 108 and below the house 112, includes utilities that are functionally interconnected to associated appliances in the house 112.

The illustrated embodiments of travel trailer 100 are designed to be mechanically coupled to a towing vehicle (e.g., car, truck, sport utility vehicle). The chassis 108 includes a frame 120 that supports two pairs of axle-mounted wheels 124. Frame 120 includes a first longitudinal member 126 (e.g., a first I-beam), and a second longitudinal member 128 (e.g., a second I-beam). One or more lateral support members such as 130 can extend between the two members 126, 128 to help provide structural rigidity to the chassis 108. The travel trailer 100 also includes a hitch 132 (e.g., a coupler, a tongue) positioned at a front end of the chassis 108 for coupling to a corresponding component (e.g., a ball) of the towing vehicle such that the towing vehicle can tow or pull the travel trailer 100.

In some embodiments, the travel trailer 100 is a self-propelled towable RV. FIG. 2, for example, illustrates an electric motor 134 that is coupled to the wheels 124 and configured to provide motive force to drive the wheels. Electric motor 134 may be powered by a battery, such as for example the drive battery 136 mounted to the chassis 108. Water tanks 140, such as for example one or more fresh water tanks, one or more grey water tanks, and/or one or more black water tanks, can be mounted to the chassis 108. Other embodiments of the chassis 108 can have other configurations, such as for example other frame structures.

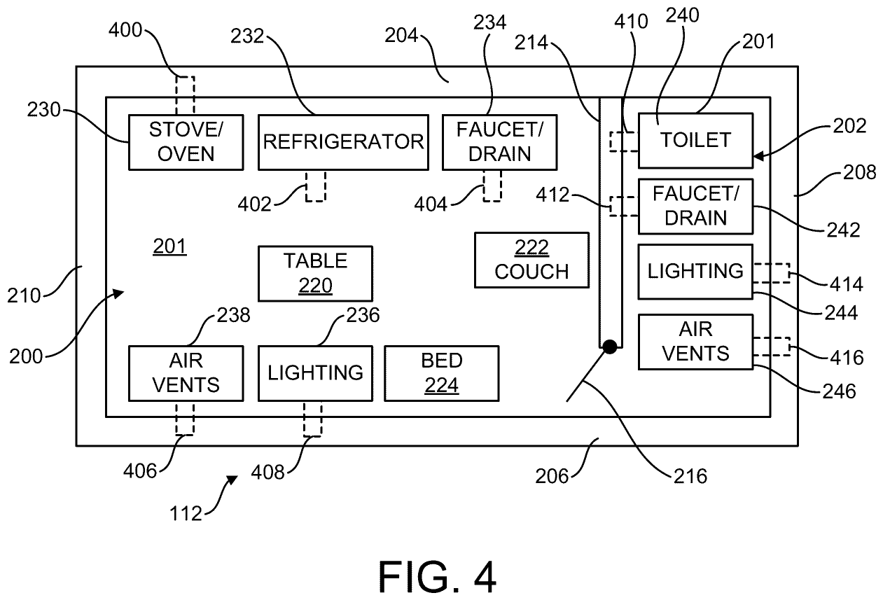

FIG. 4 is a diagrammatic illustration of an exemplary house 112, in accordance with embodiments. The illustrated embodiments of house 112 have a floorplan including a first room 200 defined by floor 201 and outer walls 204, 206, 208 and 210, and a second room 202 defined by the floor 201, outer walls 204, 206, 208, an inner wall 214 and a door 216. The illustrated embodiments of the first room 200 are configured as a kitchen/dining/lounge/sleeping area, and include furniture such as table 220, couch 222 and bed 224. The first room 200 also includes one or more appliances, shown for example as a stove (e.g., a cooktop) and/or oven 230, refrigerator 232, a sink including a water faucet and/or drain 234, lighting 236, and one or more air vents 238. The illustrated embodiments of the second room 202 are configured as a bathroom, and include one or more appliances such as a toilet 240, a sink including a water faucet and/or drain 242, lighting 244, and one or more air vents 246. Other embodiments of the house 112 can be configured with other floor plans, and/or additional and/or different appliances and/or furniture. For example, embodiments of house 112 may include appliances such as microwave ovens, garbage disposals or fans, one hundred and twenty volt electrical outlets, and/or electronic devices such as computers, mobile phones, routers or other devices that are configured to be interconnected to electronic communication networks such as the internet and/or local area networks. Yet other examples of appliances that may be included in house 112 include entertainment systems (e.g., TV, stereo, WiFi), diswashers, and/or clothes washers and dryers.

Utility layer 110 can be described with reference to FIGS. 2 and 3. As shown, the utility layer 110 includes a plurality of utilities that are coupled to and interact with structures in the house 112, such as for example the appliances in the house. In general, the utilities of the utility layer 110 can be functionally interconnected to one or more of the appliances in the house 112 to enable or otherwise support the function or operation of the appliances. The illustrated utilities include heating, ventilating, and air conditioning (HVAC) units 300 and 302, one or more water pumps such as 304, water heater 306 and filter 308, a house battery 310 and an electrical power system 312. Electrical power system 312 can, for example, be coupled to the house battery 310 and function as a power supply to provide low voltage power (e.g., 12 volts) to certain appliances, and/or can be configured to be coupled to an external source of high voltage power (e.g., 120 volts) that may be used by certain appliances. Alternatively or additionally, the electrical power system 312 may include an inverter to generate one hundred and twenty volt power from the house battery 310. Other embodiments of utility layer 110 include other utilities, such as for example a router coupled to communication networks such as the internet that provide a local network (e.g., WiFi), electrical systems that provide one hundred and twenty volt power (e.g., to any one hundred and twenty volt outlets in the house 112, a water pump, a furnace, electrical panels for fuses or circuit breakers, and/or controllers such as those including computers or processors.

In the illustrated embodiments, the utilities of the utility layer 110 are organized into compartments including a first compartment 320 housing the HVAC units 300, 302, a second compartment 322 housing the water pump 304, water heater 306 and filter 308, and a third compartment 324 housing the house battery 310 and electrical system 312. The illustrated embodiments also include a storage compartment 326, which may be configured to not contain utilities. Each of the compartments 320, 322, 324 and 326 may be defined by and separated from other compartments by interior walls such as 330, 332 and 334. The enclosure of the illustrated embodiments of utility layer 110 is also defined by a bottom or base 340, and outer walls 342, 344, 346 and 348. Embodiments of the utility layer 110 may include doors to access the utilities. FIGS. 1A and 1C, for example, shows doors 350, 352 and 354 that can be used to provide access to the utilities in the compartments 320, 324 and 326, respectively. In the illustrated embodiments, the HVAC units 300 and 302 are mounted in the compartment 320 on rolling or sliding shelf 360. When the door 350 is opened, the sliding shelf 360 and the HVAC units 300 and 302 thereon can be slid out of the compartment 320 to provide access to the HVAC units. Similarly, in the illustrated embodiments the house battery 310 and electrical system 312 are mounted in the compartment 324 on a sliding shelf 362, allowing the sliding shelf and the house battery and electrical system thereon to be slid out of the compartment for access (e.g., through door 352).

In embodiments, the enclosure of the utility layer 112 can be fully or partially manufactured as a separate or discrete unit, separate from the chassis 108 and the house 112, and mounted on and attached to the chassis during assembly of the travel trailer 100. For example, the utility layer 112 can be configured to nest and/or stack on the frame 120. The utilities can be mounted to the utility layer 112 before and/or after the enclosure of the separately-manufactured utility layer 112 is mounted to the chassis 108. The base portion of the utility layer 112, including for example the base 340, can be sized, shaped or otherwise configured to mate with the chassis 108 (e.g. on the frame 120). In embodiments, the separately-manufactured utility layer 112 can include mounting structures configured to mate with corresponding mounting structures on the frame 120, so as to enable the utility layer to be efficiently mounted to the frame 120 after being positioned thereon. By way of example, such mounting structures may include apertures in the utility layer 112 that align and mate with corresponding apertures in the frame 120, and that are configured to receive bolts or other structures to secure the utility layer to the frame. These manufacturing configurations may be enhanced by self-aligning structures on the utility layer 112 and/or frame 102.

Similar to the structures of the utility layer 110 and chassis 108 that enable the utility layer to be efficiently stacked on, aligned with and mounted to the chassis, the house 110 (e.g., the base, floor or other lower portions of the house) and utility layer (e.g., upper portions of the utility layer), can be configured to enable the house to be efficiently stacked on, aligned with and mounted to the chassis.

In other embodiments, all or portions of the utility layer 112 can be assembled directly on the frame 120. For example, each of one or more of the compartments 320, 322, 324 and 326 could be assembled separately and on the frame 120. In yet other embodiments, one or more of the compartments 320, 322, 324 and 326 can be fully or partially assembled separate from the chassis 108 and the house 112, and mounted on and attached to the chassis during assembly of the travel trailer 100. In these embodiments the separately-manufactured compartments 320, 322, 324 or 326 can include mounting structures such as those described above that are configured to mate with corresponding mounting structures on the frame 120.

The appliances in the house 112 are functionally interconnected or coupled to associated utilities in the utility layer 110. Examples of such functional interconnections include pipes or other plumbing for liquid transport, ducts for air transport, wires for power and electrical signal transport, and wireless (e.g., WiFi) networks. The functional interconnections may be made through one or more of the floor 201, outer walls 204, 206, 208, 210, and/or inner wall 214 of the house 112. Referring to the embodiments described with reference to FIGS. 3 and 4, the stove and/or oven 230 can be functionally interconnected to the electrical system 312 in the utility layer 110 by electrical wires 400 that extend through the outer wall 204 and/or floor 201 of the house 112. The refrigerator 232 can be functionally interconnected to the electrical system 312 in the utility layer 110 by electrical wires 402 that extend through the floor 201 of the house 112. The water faucet of the water faucet and/or drain 234 can be functionally interconnected to the water pump 304 by plumbing 404 that extends through the floor 201 of the house 112. The water pump 304, which can for example be connected to a fresh water tank on the travel trailer 100 directly and through the water heater 306, can thereby provide cold and/or hot water to the faucet of the water faucet and/or drain 234. The drain of the water faucet and/or drain 234 can be functionally coupled to a grey water tank on the travel trailer 100 by plumbing, either directly or thought a pump. The air vents 238 can be functionally coupled to one or more of the HVAC units 300 or 302 via one or more ducts 406 that extend through the floor 201 and/or outer wall 206 of the house 112. The lighting 236 can be functionally interconnected to the electrical system 312 in the utility layer 110 by electrical wires 408 that extend through the wall 206 of the house 112.

Appliances in the second room 202 of the house 112 can be functionally interconnected to associated utilities in the utility layer 110 by similar structures and approaches. As shown for example in FIG. 4, the toilet 240 can be functionally interconnected to the water pump 304 by plumbing 410 that extends through the floor 201 and/or inner wall 214 of the house 112. The water pump 304, which can for example be connected to a fresh water tank on the travel trailer 100, can thereby provide water for the tank and bowl of the toilet 240. The drain of the toilet 240 can be functionally coupled to a black water tank on the travel trailer 100 by plumbing, either directly or thought a pump. The water faucet of the water faucet and/or drain 242 can be functionally interconnected to the water pump 304 by plumbing 412 that extends through the floor 201 and/or interior wall 214 of the house 112. The water pump 304, which can for example be connected to a fresh water tank on the travel trailer 100 directly and through the water heater 306, can thereby provide cold and/or hot water to the faucet of the water faucet and/or drain 242. The drain of the water faucet and/or drain 242 can be functionally coupled to a grey water tank on the travel trailer 100 by plumbing, either directly or thought a pump. Lighting 244 can be functionally interconnected to the electrical system 312 in the utility layer 110 by electrical wires 414 that extend through the wall 208 of the house 112. The air vents 246 can be functionally coupled to one or more of the HVAC units 300 or 302 via one or more ducts 416 that extend through the floor 201 and/or outer wall 208 of the house 112.

Embodiments of travel trailer 100 may also include appliances in the house 112 coupled to utilities in the utility layer 110 by other functional interconnections. For example, mobile devices in the house 112 can be coupled to communication networks such as the internet via local networks (e.g., wireless or wired networks) provided by routers and/or other networking components located in the utility layer 110. In embodiments, utilities in the utility layer 110 may also be coupled to other structures and/or systems on the travel trailer 100, and/or off the travel trailer, to provide their functionality. As described above, for example, the water pump 304 can be coupled to one or more of the fresh water tank, grey water tank or black water tank on the chassis 108. The electrical system 312 can be coupled to an externally-supplied source of one hundred and twenty volt power.

Yet other variations of the travel trailer 100 are contemplated. For example, the utility layer 110 can be defined by a plurality of separately-manufactured compartments, and those compartments may be stacked together end to end (e.g., as opposed to covering the entire length of the chassis 108). The locations of components on the utility layer 110 and chassis 108 can be swapped or varied. For example, in embodiments one or more of the water tanks can be located on the utility layer 110, and/or one or more of the HVAC units can be located on the frame 120.

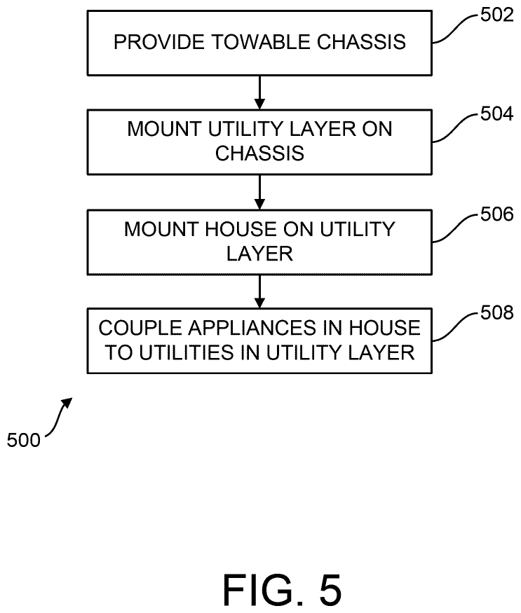

FIG. 5 is a diagrammatic illustration of a method 500 for manufacturing a travel trailer such as 100 in accordance with embodiments. As shown, the method 500 includes providing a towable chassis at step 502. The chassis can, for example, include any or all features of the chassis 108 described above.

At step 504, a utility layer is mounted on the chassis. The utility layer can, for example, include any or all of the features of the utility layer 110 described above. For example, the utility layer can include one or more utilities of the types described above. In some embodiments, mounting the utility layer on the chassis comprises mounting a utility layer including a plurality of compartments on the chassis. In some embodiments, mounting the utility layer on the chassis comprises at least partially assembling the utility layer separate from the chassis. The at least partially assembled utility layer, which may include a plurality of compartments, can then be mounted to the chassis. Alternatively and/or additionally, other approaches described herein for assembling the utility layer and/or mounting the utility layer on the chassis can be incorporated into step 504. One or more of the utilities can be mounted to the utility layer after the compartments are assembled onto the chassis. Alternatively or additionally, one or more utilities can be mounted to the compartments or other structures before those structures are mounted on to the chassis.

At step 506, the house is mounted to the utility layer. The house can, for example, include any or all of the features of the house 112 described above. For example, the house can include one or more appliances of the types described above. Approaches of the types described herein for mounting the house to the utility layer can be incorporated into step 506.

At step 508, the appliances in the house are coupled to the utilities in the utility layer. The appliances are thereby functionally interconnected to the utilities. For example, the functional interconnections can include one or more of the types of functional interconnections described above. Approaches of the types described above for coupling the appliances to the utilities can be incorporated into step 508.

RVs such as travel trailers 100 including utility layers such as 110 and manufactured by methods such as 500 described above can provide importance advantages. For example, they allow certain utilities to be moved out of the main living areas of the house 112, and to be packaged and routed in the utility layer 110. Similarly, functional interconnections between the utilities and associated appliances can be routed through the floor 201 and/or walls such as 204, 206, 208, 210 and 214 of the house 112, and/or through the utility layer 110, thereby increasing the amount space in the house available for other uses. This middle layer functionality provided by the utility layer 110 enhances the efficiencies by which the travel trailer 100 can be manufactured, for example by increasing the efficiency of routing components such as electrical wires, ductwork and plumbing. Processes for both initial assembly and serviceability of the travel trailer 100 can also be simplified and otherwise enhanced. The overall height of the travel trailer 100 can be reduced, for example by locating utilities such as the HVAC units 300, 302 in the utility layer rather than on the roof of the travel trailer.

### Recreational Vehicles With Module-based Houses

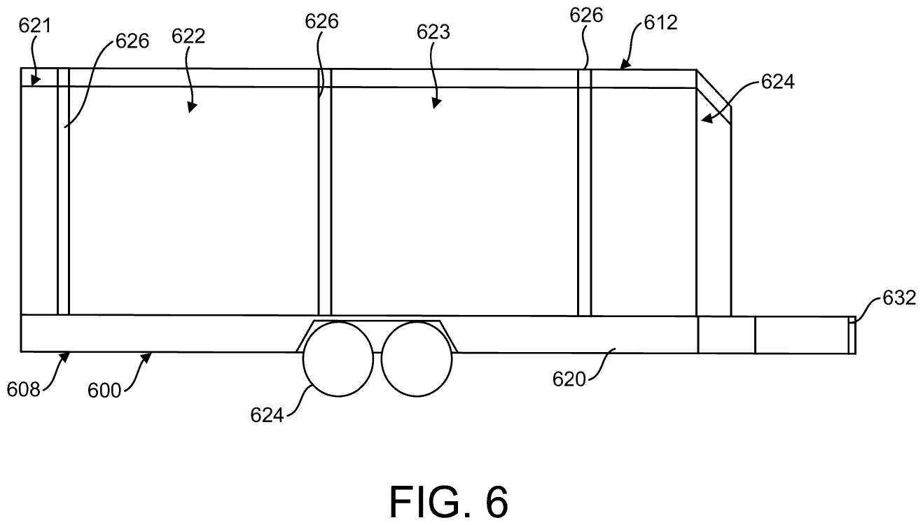

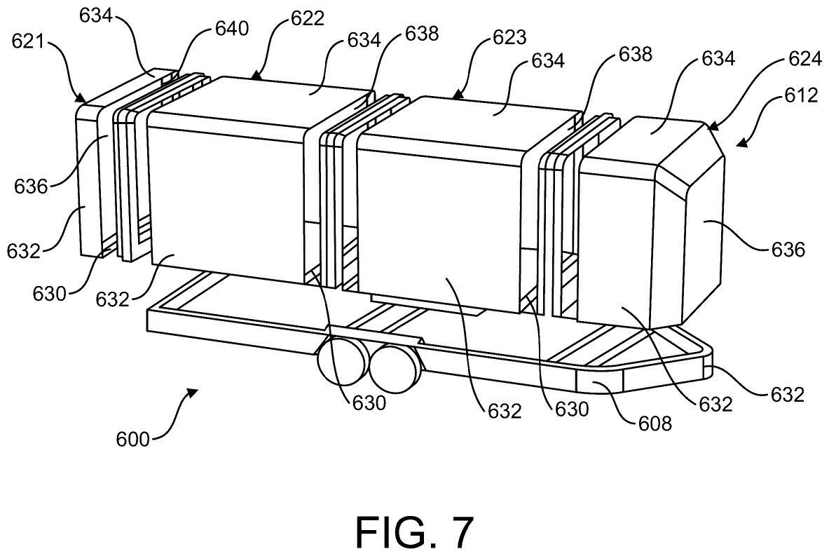

FIG. 6 is diagrammatic illustration of a towable recreational vehicle (RV) such as a travel trailer 600, which includes a chassis 608 and a modular house 612 in accordance with embodiments. FIG. 7 is an exploded diagrammatic illustration of the travel trailer 600. The house 612, which is mounted to the chassis 608, is a body that houses a living area including one or more appliances and one or more furniture items such as for example those described above in connection with the travel trailer 100. One or more utilities, such as for example the utilities described above in connection with travel trailer 100, are functionally interconnected to associated appliances in the house 612, and in embodiments can be located in the house 612. Additionally or alternatively, and as described above for example in connection with the travel trailer 100, one or more utilities that are functionally interconnected to associated appliances in the house 612 can be located on the chassis 608.

The illustrated embodiments of travel trailer 600 are designed to be mechanically coupled to a towing vehicle (e.g., car, truck, sport utility vehicle). The chassis 608 includes a frame 620 that supports two pairs of axle-mounted wheels 624. The travel trailer 600 also includes a hitch 632 (e.g., a coupler, a tongue) positioned at a front end of the chassis 608 for coupling to a corresponding component (e.g., a ball) of the towing vehicle such that the towing vehicle can tow or pull the travel trailer 600. Alternatively or additionally, the chassis 608 can include one or more features of the chassis 108 of the travel trailer 100 described above. For example, the travel trailer 600 may be a self-propelled towable RV, and include an electric motor coupled to the wheels and configured to provide motive force to drive the wheels. The electric motor may be powered by a battery, such as for example a drive battery mounted to the chassis 608. Water tanks, such as for example one or more fresh water tanks, one or more grey water tanks, and/or one or more black water tanks, can be mounted to the chassis 608.

The house 612 is formed from a plurality of house modules, such as for example modules 621, 622, 623 and 624, that are mounted adjacent to one other on the chassis 608. As described in greater detail below, one or more, or all, of the modules 621-624 may be at least partially preassembled or manufactured before being mounted to the chassis 608. Adjacent modules 621-624 may be joined or connected by connecting structures such as seals 626.

Modules 621-624 include a number of structural components such as a base or floor 630, a pair of sides such as side walls 632, and a top such as roof 634, that define at least portions of an enclosure. In the embodiments shown in FIGS. 6 and 7, the modules 621 and 624 are rear and front end cap modules, respectively, located on the opposite ends of the house 612. End cap modules 621 and 624 include end walls 636 in the illustrated embodiments. Modules 622 and 623 are interior modules located between the end cap modules 621 and 624. In the illustrated embodiments, the house 612 is configured to enable users to gain access to each of the modules 621-624 from within the house, and the interior modules 622 and 623 include openings 638 on both of their opposite ends to provide such assess. End cap modules 621 and 624 include openings 640 on their ends opposite the end walls 636 to provide such access. Embodiments of the modules 621-624 may also include walls on one or more of their opposite ends that are adjacent to the other modules, and in those embodiments the openings 638 on the ends may be defined by a door or other structure that can be opened to provide the access to an adjacent module, and closed. Other embodiments of the modules include no wall structures or partial wall structures (e.g., half-height walls extending from the floors) on their opposite ends that are adjacent to other modules to provide full or partial access between the adjacent modules. In still other embodiments, one or more of the modules 621-624 may include one or more walls on their ends adjacent to other modules, and thereby effectively prevent access to such modules from an adjacent module (e.g., such modules, such as storage modules, may be configured for access from outside of the house). One or more of the modules 621-624 may also include one more fenestration structures such as doors and/or windows (e.g., on the side walls 632 and/or the end walls 636).

Modules such as 621-624 may take the form of one or more different use configurations. Each of the different use configurations may be designed for different types of activities, and may include different floor plans, different types of furniture, different types of appliances and/or different types of utilities associated with the designed-for activities. One or more, or all, of the modules 621-624 can have one or more similar structural features, or otherwise be standardized, so as to be adapted to be mounted to the chassis 608 and adjacent to one or more other modules. For example, the modules 621-624 can have features such as shapes, sizes, structures and/or other characteristics that enable them to be mounted to the chassis 608, and to joined, mated or otherwise structurally coupled with adjacent modules. In embodiments, one or more, or all, of the modules 621-624 are configured to mate with adjacent modules via the seals 626.

Standardizing the modules 621-624 can provide important advantages. For example, in addition to enabling the modules to be efficiently coupled to the chassis and to each other, the modules can be efficiently manufactured (e.g., at least partially preassembled before being mounted to the chassis), while providing for customization of the house. For example, in some embodiments, pre-assembled modules 621-624 include one or more, or all, components such as a floor, one or more exterior and/or interior walls, a roof, furniture, appliances and/or utilities. In some embodiments, portions of the modules 621-624 can be assembled after the modules are mounted to the chassis 608. For example, in embodiments the seals 626 may be assembled and/or joined to the modules 621-624 after the modules are mounted to the chassis 608.

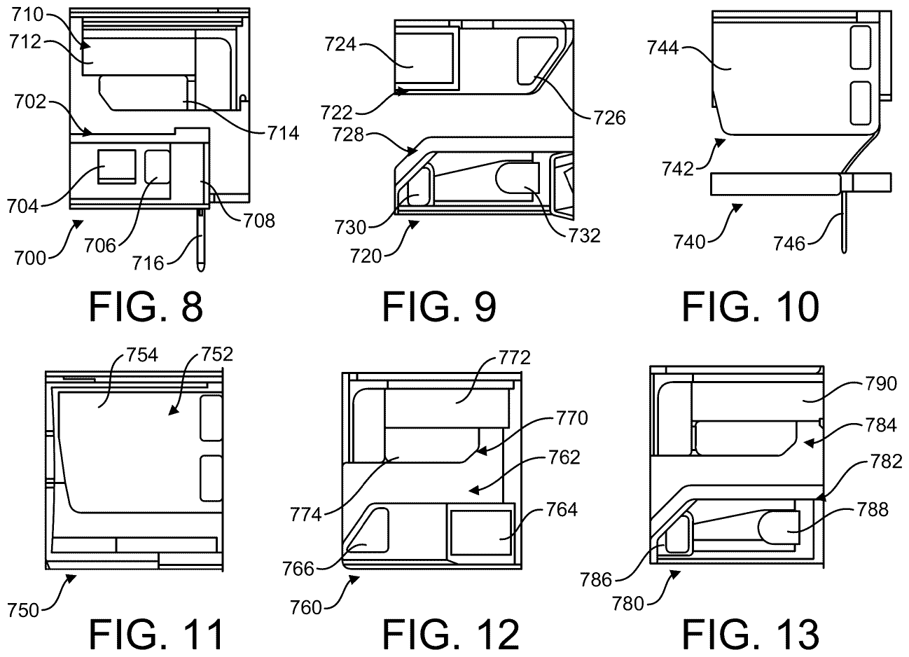

FIG. 8 illustrates a floor plan of an interior kitchen/dining/lounge module 700 in accordance with embodiments that includes a kitchen area 702 and a dining and lounge area 710. The illustrated embodiments of the kitchen area 702 include kitchen appliances such as a cooktop 704, faucet/sink 706 and refrigerator 708. Utilities associated with the appliances in the kitchen area 702 can be located in the module 700 and/or on the chassis to which the module 700 may be mounted. Dining and lounge area 710 is shown for purposes of example with furniture such as bench seating 712 table 714. The illustrated embodiment of module 700 also includes a door 716 on the side wall 718.

FIG. 9 illustrates a floor plan of an interior bathroom/kitchen module 720 in accordance with embodiments that includes a kitchen area 722 and a bathroom area 728. The kitchen area 722 is shown for purposes of example with kitchen appliances such as a cooktop 724 and faucet/sink 726. Bathroom area 728 is shown for purposes of example with appliances such as a shower 730 and a toilet 732. Utilities associated with the appliances in the kitchen area 722 and bathroom area 728 can be located in the module 720 and/or on the chassis to which the module 700 may be mounted.

FIG. 10 illustrates a floor plan of an interior bedroom module 740 in accordance with embodiments that includes a sleeping area 742. The sleeping area 742 is shown for purposes of example with furniture such as a bed 744. The illustrated embodiment of module 740 also includes a door 746 on the side wall 748.

FIG. 11 illustrates a floor plan of an interior bedroom module 750 in accordance with embodiments that includes a sleeping area 752 having a bed 754.

FIG. 12 illustrates a floor plan of an interior kitchen/dining/lounge module 760 in accordance with embodiments that includes a kitchen area 762 and a dining and lounge area 770. The illustrated embodiments of the kitchen area 762 include kitchen appliances such as a cooktop 764 and faucet/sink 766. Utilities associated with the appliances in the kitchen area 762 can be located in the module 760 and/or on the chassis to which the module 760 may be mounted. Dining and lounge area 770 is shown for purposes of example with furniture such as bench seating 772 and table 774.

FIG. 13 illustrates a floor plan of an interior bathroom/dining/lounge module 780 in accordance with embodiments that includes a bathroom area 782 and a dining and lounge area 784. Bathroom area 782 is shown for purposes of example with appliances such as a shower 786 and a toilet 788. Utilities associated with the appliances in the kitchen area bathroom area 782 can be located in the module 780 and/or on the chassis to which the module 780 may be mounted. The dining and lounge area 784 is shown for purposes of example with furniture such as bench seating 790 and table 792.

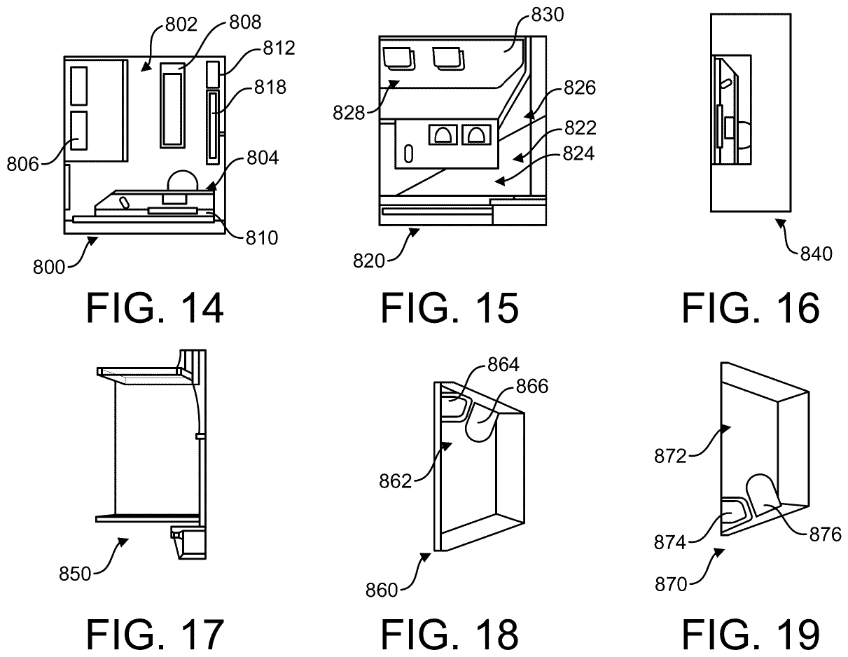

FIG. 14 illustrates a floor plan of an interior bedroom/lounge module 800 in accordance with embodiments that includes a combined or overlapping bedroom area 802 and lounge area 804. The bedroom/lounge module 800 is shown for purposes of example with furniture such as a fold-out or otherwise collapsible sofa bed 806, table 808, cabinet 810 and stand or shelf 812. Appliances such as for example a television or monitor 818 can be located in the module 800. Utilities such as an electrical outlet coupled to the monitor 818 can be located in the module 800.

FIG. 15 illustrates a floor plan of an interior kitchen/dining/lounge/sleeping module 820 that includes combined or overlapping kitchen area 822, dining area 824, lounge area 826 and sleeping area 828. The module 820 is shown for example with furniture including a fold-out or otherwise collapsible sofa bed 830. The kitchen area 822 is shown for example with a table 832. Other embodiments of interior modules can include other floor plans with other appliances, furniture and/or associated utilities.

FIG. 16 illustrates a floor plan of one embodiment of a rear end cap folding deck module 840. FIG. 17 illustrates a floor plan of another embodiment of a rear end cap folding deck module 850. The embodiment shown in FIG. 17 includes a desk or table. Other embodiments of rear end cap modules can include other floor plans, and can also include one or more appliances, furniture and/or associated utilities. Rear end cap modules can also include one or more opening features such as a door, ramp or clamshell.

FIG. 18 illustrates a front end cap bathroom module 860 that includes a bathroom area 862. Bathroom area 862 is shown for purposes of example with appliances such as a shower 864 and a toilet 866. Utilities associated with the appliances in the bathroom area 862 can be located in the module 860 and/or on the chassis to which the module 860 may be mounted.

FIG. 19 illustrates a front end cap bathroom module 870 that includes a bathroom area 872. Bathroom area 872 is shown for purposes of example with appliances such as a shower 874 and a toilet 876. Utilities associated with the appliances in the bathroom area 872 can be located in the module 870 and/or on the chassis to which the module 870 may be mounted. The shower 874 and toilet 876 are shown located on the opposite side of the module 870 with respect to the shower 864 and toilet 876 of the module 860 shown in FIG. 18.

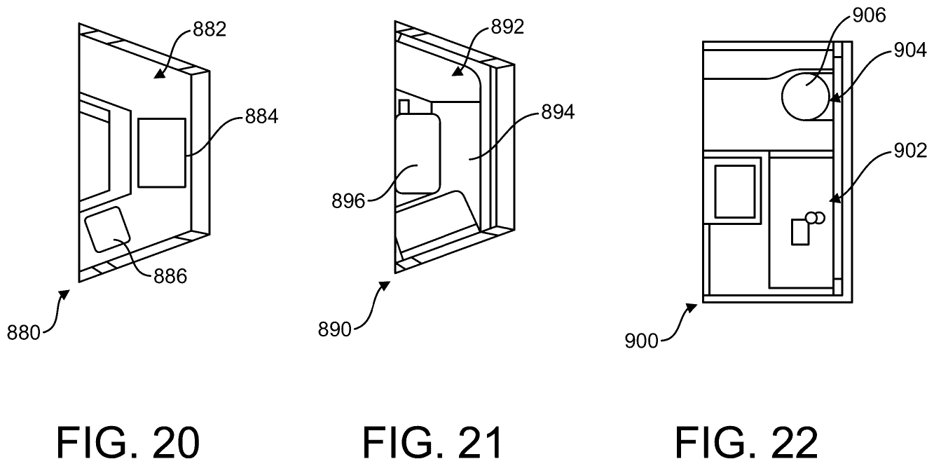

FIG. 20 illustrates a front end cap kitchen module 880 that includes a kitchen area 882. The kitchen area 882 is shown for purposes of example with appliances such as cooktop 884 and faucet/sink 886. Utilities associated with the appliances in the kitchen area 882 can be located in the module 880 and/or the chassis to which the module may be mounted.

FIG. 21 illustrates a front end cap lounge module 890 that includes a lounge area 892. The lounge area 892 is shown for purposes of example with furniture such as seating 894 and table 896. The lounge module 890 may also include appliances such as electrical outlets or lighting.

FIG. 22 illustrates a front end cap kitchen/bathroom module 900 that includes a kitchen area 902 and a bathroom area 904. The kitchen area 902 is shown for purposes of example with appliances such as a microwave oven and/or stove (e.g., cooktop and/or oven). The bathroom area 904 is shown for purposes of example with appliances such as a toilet 906. Utilities associated with the appliances in the kitchen area 902 and/or the bathroom area 904 can be located in the module 900 and/or the chassis to which the module may be mounted. Other embodiments of front end cap modules can include other floor plans, and can also include one or more appliances, furniture and/or associated utilities.

In embodiments, two or more, or all, of the interior modules such as 700, 720, 740, 750, 760, 780, 800 and 820 can have the same or substantially the same length (e.g., a standard length). For example, two or more or all of these modules can have a length of seven feet. Similarly, two or more, or all, of the rear end cap modules such as 840 and 850 can have the same or substantially the same length, and/or two or more, or all, of the front end cap modules such as 860, 870, 880, 890 and 900 can have the same or substantially the same length. For example, in embodiments, two or more of the interior modules can have a length of about seven feet, two or more of the rear end cap modules can have a length of about one foot, and two or more of the front end cap modules can have a length of about four feet.

The modular and structural features of house modules of the types described herein enable the efficient manufacturing of travel trailers or other RVs, while at the same time allowing those RVs to be customized by or for users. In connection with this capability of providing customizable RVs, travel trailers such as 600 shown in FIGS. 6 and 7, which may be referred to as a double or two (interior) module trailers, and can be manufactured in a wide variety of configurations. In embodiments, the different configurations of double module trailers 600 can be manufactured using a chassis 608 of a particular size, including length, that is configured to receive two standard size interior modules and also a standard size rear end cap module and a standard size front end cap module. Chasses such as 608 of these type configured for use with standard double module trailers may be referred to as standard double module chasses.

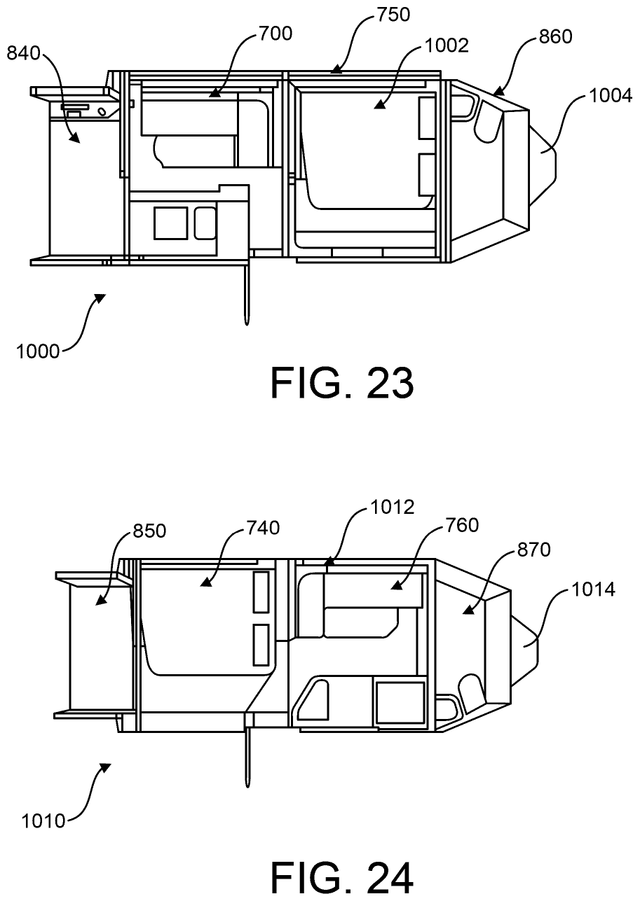

FIG. 23, for example, illustrates a floor plan of a double module trailer 1000 including a house 1002 on a standard double module chassis 1004. House 1002 includes an interior kitchen/dining/lounge module 700 and an interior bedroom module 750 of the types described above in connection with FIGS. 8 and 11, respectively, with a rear end cap folding deck module 840 and front end cap bathroom module 860 of the types described above in connection with FIGS. 16 and 18, respectively.

FIG. 24 illustrates a floor plan of a double module trailer 1010 including a house 1012 on a standard double module chassis 1014. House 1012 includes an interior bedroom module 740 and an interior kitchen/dining/lounge module 760 of the types described above in connection with FIGS. 10 and 12, respectively, with a rear end cap folding deck module 850 and a front end cap bathroom module 870 of the types described above in connection with FIGS. 17 and 19, respectively.

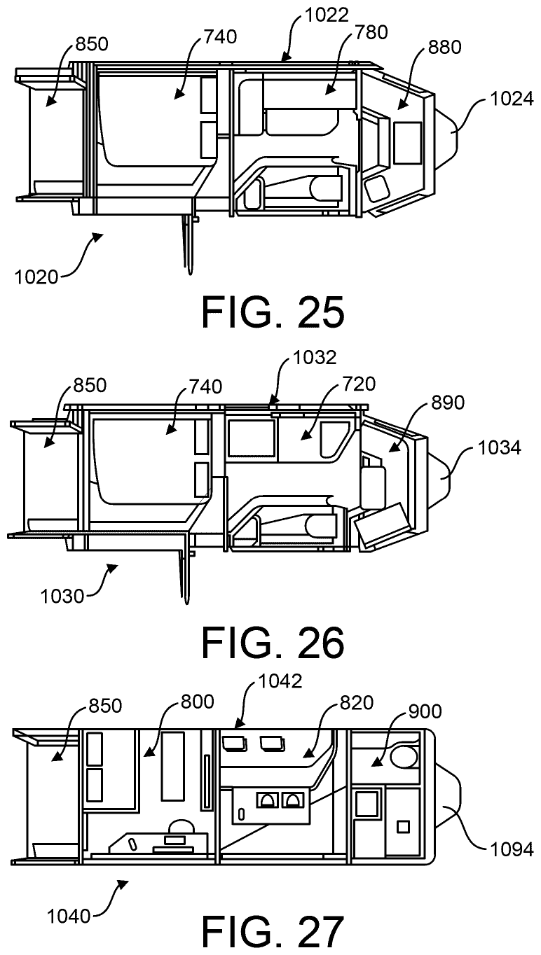

FIG. 25 illustrates a floor plan of a double module trailer 1020 including a house 1022 on a standard double module chassis 1024. House 1022 includes an interior bedroom module 740 and an interior bathroom/dining/lounge module 780 of the types described above in connection with FIGS. 10 and 13, respectively, with a rear end cap folding deck module 850 and a front end cap kitchen module 880 of the types described above in connection with FIGS. 17 and 20, respectively.

FIG. 26 illustrates a floor plan of a double module trailer 1030 including a house 1032 on a standard double module chassis 1034. House 1032 includes an interior bedroom module 740 and an interior bathroom/kitchen module 720 of the types described above in connection with FIGS. 10 and 9, respectively, with a rear end cap folding deck module 850 and a front end cap lounge module 890 of the types described above in connection with FIGS. 17 and 21, respectively.

FIG. 27 illustrates a floor plan of a double module trailer 1040 including a house 1042 on a standard double module chassis 1044. House 1042 includes an interior bedroom lounge module 800 and an interior kitchen/dining/lounge/sleeping module 820 of the types described above in connection with FIGS. 14 and 15, respectively, with a rear end cap folding deck module 850 and a front end cap kitchen/bathroom module 900 of the types described above in connection with FIGS. 17 and 22, respectively.

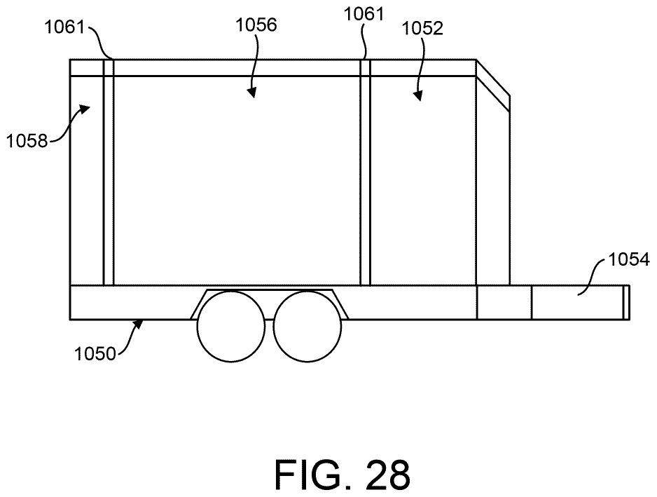

FIG. 28 is a diagrammatic illustration of a travel trailer 1050 that may be referred to as single or one (interior) module trailer consistent with the customizable capabilities described herein. As shown, the travel trailer 1050 includes a house 1052 which is mounted to a standard single module chassis 1054. House 1052 is formed by one interior module 1056 between a rear end cap module 1058 and a front end cap module 1060. The interior module 1056 can, for example, be one of the modules 700, 720, 740, 750, 760, 780, 800 or 820 described above in connection with FIGS. 8-15, respectively. The rear end cap module 1058 can, for example, be one of the rear end cap modules 840 or 850 described above in connection with FIGS. 16-17. The front end cap module 1060 can be one of the front end cap modules 860, 870, 880, 890 or 900 described above in connection with FIGS. 18-22. Adjacent modules 1056, 1058 and 1052 can be connected by structures such as seals 1061.

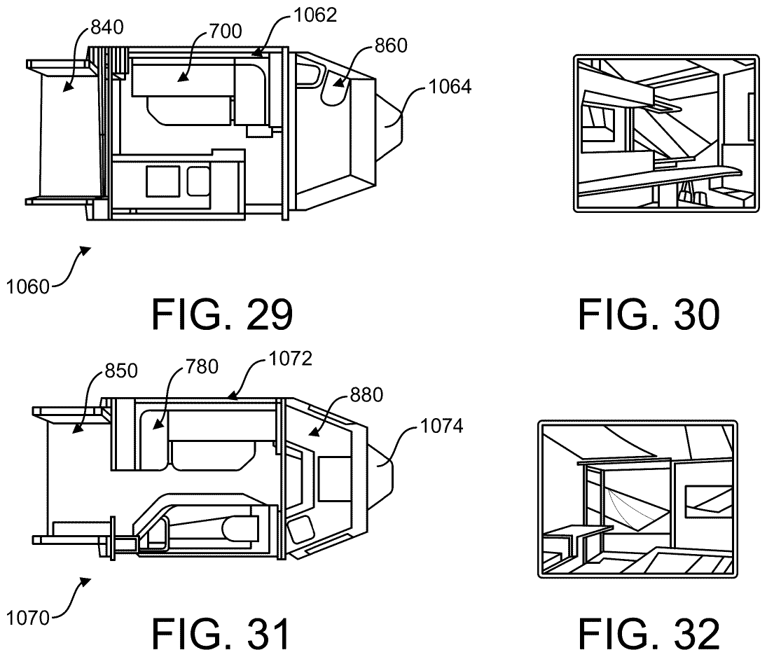

FIG. 29 illustrates a floor plan of a single module trailer 1060 including a house 1062 on a standard single module chassis 1064. House 1062 includes an interior kitchen/dining/lounge module 700 of the type described above in connection with FIG. 8, with a rear end cap folding deck module 840 and a front end cap bathroom module 860 of the types described above in connection with FIGS. 16 and 18, respectively. FIG. 30 is an illustration of the house 1062, taken from within the kitchen/dining/lounge module 700 looking toward and into the folding deck module 840.

FIG. 31 illustrates a floor plan of a single module trailer 1070 including a house 1072 on a standard single module chassis 1074. House 1072 includes an interior bathroom/dining/lounge module 780 of the type described above in connection with FIG. 13, with a rear end cap folding deck module 850 and front end cap kitchen module 880 of the types described above in connection with FIGS. 17 and 20, respectively. FIG. 32 is an illustration of the house 1072, taken from within the bathroom/dining/lounge module 780 looking toward and into the folding deck module 850.

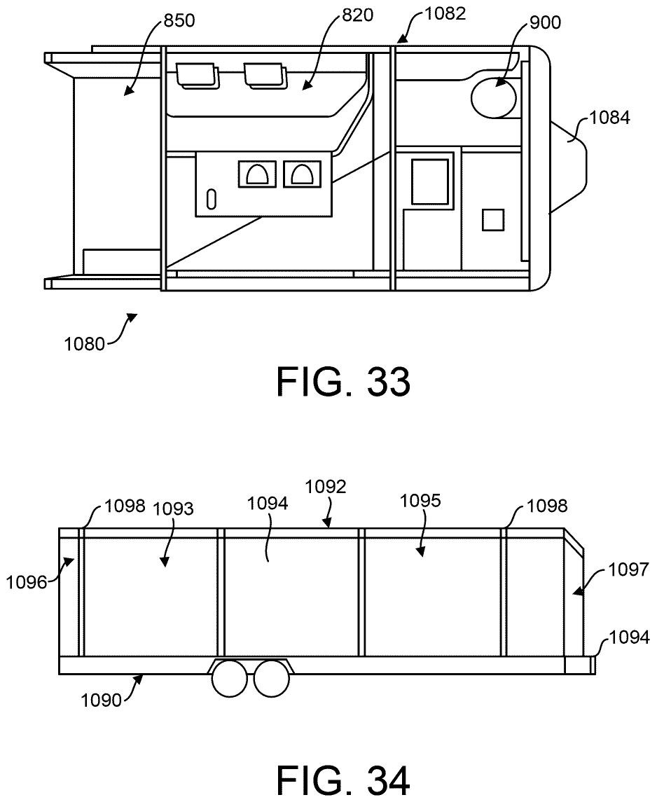

FIG. 33 illustrates a floor plan of a single module trailer 1080 including a house 1082 on a standard single module chassis 1084. House 1080 includes an interior kitchen/dining/lounge/sleeping module 820 of the type described above in connection with FIG. 15, with a rear end cap folding deck module 850 and a front end cap kitchen/bathroom module 900 of the types described above in connection with FIGS. 17 and 22, respectively.

FIG. 34 is a diagrammatic illustration of a travel trailer 1090 that may be referred to as triple or three (interior) module trailer consistent with the customizable capabilities described herein. As shown, the travel trailer 1090 includes a house 1092 which is mounted to a standard triple module chassis 1094. House 1092 includes three interior modules 1093, 1094 and 1095 adjacent to one another, and between a rear end cap module 1096 and a front end cap module 1097. Each of the interior modules 1093-1095 can, for example, be one of the modules 700, 720, 740, 750, 760, 780, 800 or 820 described above in connection with FIGS. 8-15, respectively. The rear end cap module 1096 can, for example, be one of the rear end cap modules 840 or 850 described above in connection with FIGS. 16-17. The front end cap module 1097 can be one of the front end cap modules 860, 870, 880, 890 or 900 described above in connection with FIGS. 18-22. Adjacent modules 1093-1097 can be connected by structures such as seals 1098.

In some embodiments, the interior modules such as 700, 720, 740, 750, 760, 780, 800 and 820 can have the same length. For example, in embodiments the interior modules may have a length of about seven feet. Similarly, in embodiments the rear cap modules such as 840 and 850 may have the same length, such as about one foot. Embodiments of the front cap modules such as 860, 870, 880, 890 and 900 may also have the same length, such as for example about four feet.

In some embodiments, the structures of the seals such as 626, 1061 and 1098 are configured to couple adjacent interior modules, rear end cap modules and front end cap modules of these types that are spaced apart from one another by the same distance. For example, in embodiments the seals are configured to accommodate adjacent modules spaced apart from one another by about four inches. In embodiments having interior modules, rear end cap modules, front end cap modules, and seals with these exemplary lengths, the houses such as 1053 of single module trailers such as 1050 shown in FIG. 28 will have an overall length of about thirteen feet, the houses such as 612 of double module trailers such as 600 shown in FIG. 6 will have an overall length of about twenty feet, and the houses such as 1092 of triple module trailers such as 1090 shown in FIG. 34 will have an overall length of about twenty seven feet. The associated standard size chasses such as the single module chassis 1054 of the single module trailer 1050, double module chassis 608 of the double module trailer 600, and triple module chassis 1094 of the triple module trailer 1090, can have the same lengths to accommodate houses of these lengths.

Yet other embodiments of interior modules, rear end cap modules and front end cap modules have different lengths. For example some embodiments of interior modules can have lengths of about fourteen feet. Similar to the seven foot interior modules, interior modules having lengths of fourteen feet may be configured with different floor plans to enable customization of the trailers. Embodiments of interior modules, including the interior modules having fourteen foot lengths, can also be configured with rotating or pop-out sections that allow the living space in the modules to be enlarged, for example in a direction generally perpendicular to their lengths, when the trailers that include such pop-out sections are stationary (e.g. parked at a campsite). Embodiments of trailers including different length interior modules can be configured to be incorporated into houses on standard size chasses. For example, a trailer including a house with a fourteen foot long interior module, a one foot long rear end cap module, and a four foot long front end cap module, where the interior module, rear end cap module and front end cap module are joined by four inch seals, can have an overall length of about twenty feet, and can be mounted to a standard double module chassis.

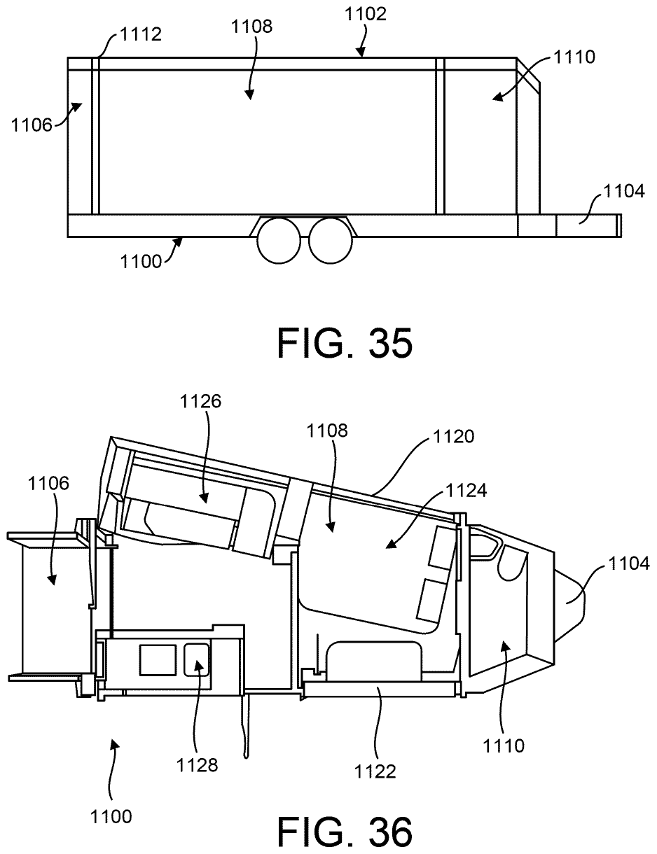

FIG. 35 illustrates a single (interior) module trailer 1100 that includes a house 1102 on a chassis 1104. House 1102 includes a rear end cap module 1106, interior module 1108 and front end cap module 1110. Structures such as seals 1112, which can for example be about four inches in length, extend between and connect the adjacent modules 1106, 1108 and 1110. In embodiments, the interior module 1108 is about fourteen feet in length. Rear end cap module 1106 is about one foot in length in embodiments, and can for example be one of the rear end cap modules 840 or 850 described above in connection with FIGS. 16-17. The front end cap module 1110 is about four feet in length in embodiments, and can for example be one of the front end cap modules 860, 870, 880, 890 or 900 described above in connection with FIGS. 18-22. In embodiments of house 1102 having an interior module 1108, rear end cap module 1106, front end cap module 1110 and seals 112 with these exemplary lengths, the house will have an overall length of about twenty feet. Accordingly chassis 1104 can be a standard double module chassis.

FIG. 36 illustrates a floor plan of an exemplary long-length single (interior) module trailer 1100 including a fourteen foot interior module 1108, rear end cap module 1106 and front end cap module 1110 on a double module chassis 1104. As shown, the module 1108 includes a rotating or pop-out section 1120 and a fixed section 1122. The pop-out section 1120 rotates or swings with respect to the fixed section 1122 between a first width or retracted position, and a second width or extended position shown in FIG. 36. When in the retracted position, the module 1108 has a first width configured to allow the trailer 1100 to be towed or otherwise moved. The first width can, for example, be a width that is the same as or similar to widths of the rear end cap module 1106 and/or the front end cap module 1110 (e.g., so that the house 1102 has a generally common width). When in the extended position shown in FIG. 36, at least portions of the module 1108 have a second width that is greater than the first width, to provide increased living area space within the module, such as for example when the module is parked at a campsite.

In the illustrated embodiments, the module 1108 is configured as a bedroom/dining/kitchen module, and includes a bedroom area 1124, dining area 1126, and a kitchen area 1128. Other embodiments of the module 1108 are configured for other uses, such as for example with a bathroom. The illustrated embodiments of the house 1108 include a rear end cap module 1106 configured as a folding deck, and a front end cap module 1110 configured as a bathroom. In other embodiments the rear end cap module 1106 and the front end cap module 1110 are configured for other uses.

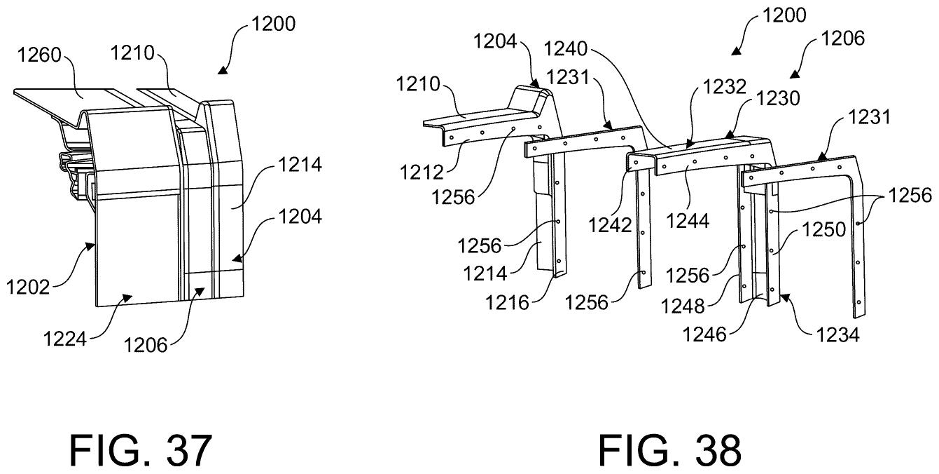

FIG. 37 is an illustration of a portion of a house 1200, including a first module 1202 and a second module 1204, and a seal 1206 joining the first and second modules. FIG. 38 is an exploded view of portions of the house 1200, illustrating portions of the second module 1204 and the seal 1206. As shown, the second module 1204 includes an end section defining an upper or roof portion 1210 including a roof flange 1212 and a side wall portion 1214 including a wall flange 1216. The first module 1202 may also include an end section defining an upper roof portion including a roof flange and a side wall portion 1224 including a wall flange. In embodiments, for example, the end section of the first module 1202 may be a structure that is a mirror image of and complementary to the end section of the second module 1204. The seal 1206 includes a hoop component in the form of a structural member 1230 and a pair of gaskets such as rubber seals 1231 on the opposite sides of the structural member 1230. The seal 1206 is a mating member that attaches to the end sections of both the first module 1202 and the second module 1204, and between the first and second modules. The seal 1206 joins the first module 1202 and the second module 1204, and provide a relatively air-tight and water-tight seal between the first and second modules. Structures such as electrical wires and plumbing that couple appliances in the modules to associated utilities can be located with the seal 1206.

In the illustrated embodiments, the structural member 1230 includes a U-shaped member that defines an upper or roof portion 1232 and a side wall portion 1234. The roof portion 1232 includes a central member 1240 and a pair of roof flanges 1242 and 1244 extending from the opposite ends of the central member. Similarly, the side wall portion 1234 includes a central member 1246 and a pair of wall flanges 1248 and 1250 extending from the opposite ends of the central member. The roof flange 1242 and wall flange 1248 of the structural member 1230 are configured (e.g. sized and shaped) to mate with the roof flange 1212 and wall flange 1216, respectively, of the end section of the second module 1204. Similarly, the roof flange 1244 and wall flange 1250 of the structural member 1230 are configured to mate with the roof flange and wall flange of the end section of the first module 1202. A gasket 1231 is configured (e.g., sized and shaped) to be located between the roof flange 1212 and wall flange 1216 of the second module 1204 and the roof flange 1242 and wall flange 1248 of the structural member 1230, respectively, Similarly, a gasket 1231 is configured to the located between the roof flange 1244 and wall flange 1250 of the structural member 1230 and the roof flange and wall flange, respectively, of the first module 1202. The structural member 1230 can be secured to the first module 1202 and/or the second module 1204, for example with the gaskets 1231 between the structural component and the first and second modules, by fasteners such as bolts or screws, or other approaches such as adhesives. The illustrated examples of the structural member 1230, first module 1202, second module 1204 and gaskets 1231 include holes 1256 that can be used to receive fasteners of these types. Embodiments of the seal 1206 may also include a roof member or cap 1260 that extends over the roof portion 1232 of the structural component 1230 and one or both of the adjacent portions of gaskets 1231. The cap 1260 may also extend beyond one or both of the gaskets 1231, and over portions of the roof of one or both of the first module 1202 and/or second module 1204, in embodiments.

Other embodiments of seals for coupling the house modules can include other structures. For example, the seals can include more or fewer components. Separate and optionally different seal structures can be configured to join the roof portions and the wall portions of adjacent modules. Seal structures such as those described herein, or other seal structures, can be used to join the bases or floors of adjacent modules.

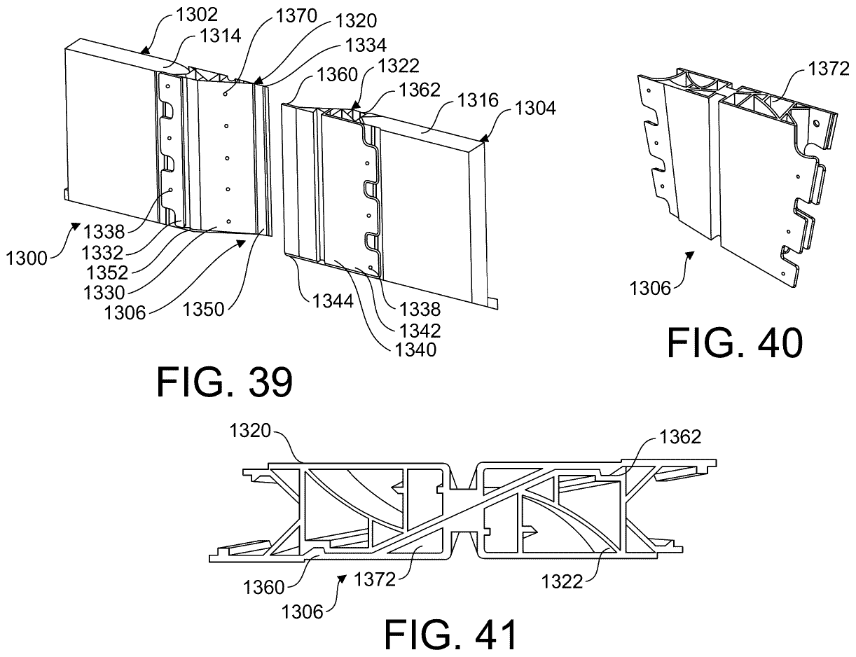

FIG. 39 is an illustration of a portion of a house 1300, including a first module 1302 and a second module 1304, and a seal 1306 joining the first and second modules. FIGS. 40 and 41 are illustrations of the seal 1306. As shown, the first module 1302 includes an end section defining a side wall portion 1314. Similarly, the second module 1304 includes an end section defining a side wall portion 1316. The seal 1306 includes a first connection section 1320 mounted to the side wall portion 1314 of the first module 1302, and a second connection section 1322 mounted to the side wall portion 1316 of the second module 1304. The first section 1320 and second section 1322 of the seal 1306 are configured to connect or couple to one another, to join the first module 1302 to the second module 1304, and to provide a relatively air-tight and water-tight seal between the first and second sections. Structures such as electrical wires and plumbing that couple appliances in the modules to associated utilities can be located within the seal 1306.

The first section 1320 of the seal 1306 includes a body 1330 defining a first edge section or end 1332 that is attached to the side wall portion 1314 of the first module 1302, and a second edge section or end 1334. In embodiments, fasters such as screws, or other approaches such as adhesives, can be used to attach the second end 1334 of the first section 1320 of the seal 1306 to the side wall portion 1314 of the first module 1302. The illustrated embodiments of the first section 1320 of the seal 1306 includes holes 1338 that can, for example, be configured to receive fasteners to attach the first section of the seal to the first module. Similarly, the second section 1322 includes a body 1340 defining a first edge or end 1342 with holes 1338 that is attached to the side wall portion 1316 of the second module 1302, and a second edge section or end 1344. The first and second bodies 1330 and 1340 of the seal 1306 are configured to be attached to one another to join the first module 1302 and the second module 1304.

In the illustrated embodiments, the first and second bodies 1330 and 1340 are configured to interlock with one another. In these embodiments the first and second bodies 1330 and 1340 are complimentary, and can be identical but positioned on the first module 1302 and second module 1304 in opposing orientations. The first body 1330 is tapered or sloped, and has decreasing thickness with increasing distance from its first end 1332. A snap lock tab structure 1350 is located on the second end 1334, and a snap lock receiver structure 1352 is located on the first end 1332, of the first body 1330. Similarly, the second body 1340 is tapered or sloped, and has decreasing thickness with increasing distance from its first end 1342. A snap lock tab structure 1360 is located on the second end 1344 of the second body 1340, and a snap lock receiver structure 1362 is located on the first end 1342 of the second body. As perhaps best shown in FIGS. 40 and 41, the first and second bodies 1330 and 1340 overlap and mate, and are coupled together by the snap lock tab structure 1350 of the first body 1330 engaging the snap lock receiver structure 1362 of the second body 1340, and the snap lock tab structure 1360 of the second body engaging the snap lock receiver structure 1352 of the first body. Fasteners such as screw or bolts, or other approaches such as adhesives, can be used to join the first and second bodies 1330 and 1340 in embodiments, and the illustrated embodiments include holes 1370, for example, to facilitate such approaches. The illustrated embodiments of the first and second bodies 1330 and 1340 include hollow structures such as 1372 that can, for example, be configured to receive insulation material and/or the functional interconnections between appliances and utilities.

Recreational vehicles with modular houses in accordance with this disclosure offer important advantages. A model lineup provided by a manufacturer may include a set of modules that can be selected in a number of possible combinations and sequences (e.g., orders, from front to back of the vehicle) Consumers and others can thereby customize units based on factors such as desired length and floor plan preferences. This approach follows principles of design for manufacturing and assembly, whereby the modules can be prefabricated as partial or complete units before being mounted to a chassis. The modules can then be placed on a chassis such as one of a set of standard, universal and/or integrated “skateboard” platforms that will provide some or all associated utility connections. Integration between modules is accomplished via “hoop” or other seal structures that can be standard or universal, to connect modules together and provide environmental sealing. The seal structures can also provide channels and/or other structures for electrical power, plumbing and data communications.

The rotating, pop-out or “swing slide” modules offer advantages such as reduced complexity in the slide mechanism. These modules also offer the potential for human powered slide operation, given how the weight is carried to the frame. This approach may eliminate “slide anxiety” that consumers may have in terms of not knowing if their slide motors/mechanisms will work.

Embodiments may also include exterior lights used for various features, such as turning flashing red when a slide is in operation. Other colors and modes could be used to indicate to the consumer aspects such as security warnings, vehicle status or environmental alerts.

### Recreational Vehicles With Module-based Houses on Chasses With Utility Layers

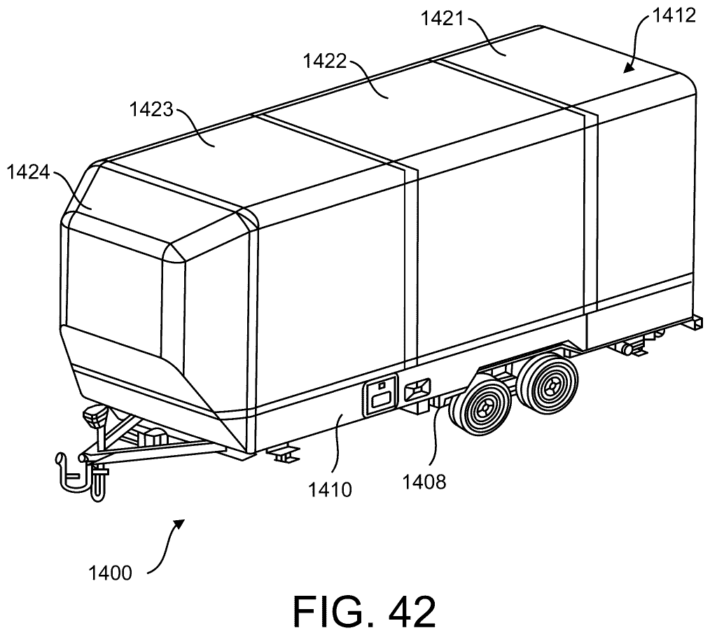

FIG. 42 is a diagrammatic illustration of a towable recreational vehicle (RV) such as travel trailer 1400, which includes a chassis 1408, utility layer 1410 and modular house 1412 in accordance with embodiments. Chassis 1408 can include one or more, or all, features of any or all embodiments of the chasses disclosed herein, such as for example the chasses 108, 608, 1054, 1094 or 1104. Utility layer 1410 can include one or more, or all, features of any or all embodiments of the utility layers disclosed herein, such as for example the utility layer 110. The illustrated embodiments of the modular house 1412 includes house modules 1421, 1422, 1423 and 1424. Modular house 1412 may include one or more, or all, features of any or all embodiments of the modular houses and associated house modules disclosed herein, such as for example houses 612, 1052, 1092 or 1102. The house modules 1421, 1422, 1423 and 1424 are joined or connected by seal structures 1426, which may include one or more, or all, features of the seals disclosed herein, such as for example seals 626, 1091, 1061, 1098, 1112, 1206 or 1306. In embodiments, one or more, or all, of the utilities in the utility layer may be arranged to be located adjacent to one or more of the house modules that include the associated appliances to which the utilities are functionally connected. In effect, travel trailer 1400 may include a combination of features of travel trailers having utility layers and modular houses in accordance with the embodiments described herein, and the associated advantages.

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

What is claimed is:

1. A recreational vehicle comprising:
a towable chassis including wheels;
a utility layer on the chassis, the utility layer including one or more utilities;
a house on the chassis above the utility layer, the house including one or more appliances; and
one or more functional interconnections, wherein each of the one or more functional interconnections couples at least one of the one or more utilities to at least one of the one or more appliances.

2. The recreational vehicle of claim 1, wherein the functional interconnections comprise one or more of plumbing, wires, or ducts.

3. The recreational vehicle of claim 2, wherein:
the one or more utilities are from a set of utilities including a battery, an electrical system, a pump, a water heater, or a heating, ventilating and air conditioning (HVAC) unit; and
the one or more appliances are from a set of appliances including a faucet, a drain, a toilet, lighting, an electrical outlet, a stove, a cooktop, a refrigerator, or one or more air vents.

4. The recreational vehicle of claim 1, wherein the utility layer comprises a side panel, and one or more of the one or more utilities are accessible through the side panel.

5. The recreational vehicle of claim 4, further comprising one or more sliding shelves, each sliding shelf mounting one or more of the one or more utilities for slidable access through the side panel.

6. The recreational vehicle of claim 1, wherein:
the house includes one or more walls; and
at least one of the one or more functional interconnections extend through the one or more walls.

7. The recreational vehicle of claim 1, wherein:
the house includes a floor; and
at least one of the one or more functional interconnections extend through the floor.

8. The recreational vehicle of claim 7, wherein:
the house includes one or more walls; and
at least one of the one or more functional interconnections extend through the one or more walls.

9. A method for manufacturing a recreational vehicle, comprising:
providing a towable chassis;
mounting a utility layer on the chassis;
mounting a house on the utility layer after mounting the utility layer on the chassis;
mounting one or more utilities on the utility layer;
mounting one or more appliances in the house; and
functionally coupling one or more of the one or more appliances to one or more of the one or more utilities.

10. The method of claim 9, wherein mounting the utility layer on the chassis comprises:
at least partially assembling the utility layer separate from the chassis; and
mounting the at least partially assembled utility layer to the chassis.

11. The method of claim 10, wherein at least partially assembling the utility layer separate from the chassis comprises:
providing a plurality of utility layer compartments, and
assembling the utility layer from one or more of the plurality of utility layer compartments.

12. The method of claim 9, wherein mounting the utility layer on the chassis comprises:
providing a plurality of utility layer compartments; and
mounting one or more of the plurality of utility layer compartments to the chassis.
